(19) United States
(12) Patent Application Publication
(10) Pub. No.: US 2015/0055027 A1
(43) Pub. Date: Feb. 26, 2015

(54) DISPLAY DEVICE

(71) Applicant: Funai Electric Co., Ltd., Osaka (JP)

(72) Inventors: Hirotsugu SUZUKI, Daito-shi (JP); Kazutoshi MIYAJIMA, Daito-shi (JP)

(21) Appl. No.: 14/452,618

(22) Filed: Aug. 6, 2014

(30) Foreign Application Priority Data
Aug. 20, 2013 (JP) 2013-170809

(51) Int. Cl. H04N 5/64

(52) U.S. Cl. CPC H04N 5/642; H04N 5/64
USPC 348/794

(57) ABSTRACT

A display device includes a liquid crystal panel, a rear frame and a rear cover disposed on a back side of the liquid crystal panel and including an opening, first protrusions on the rear frame, second protrusions on the rear frame and disposed on the side opposite from the opening, with the first protrusions being arranged between the opening and the second protrusions, a first size speaker capable of being mounted on the first protrusions, a second size speaker capable of being mounted on the second protrusions, and a covering surface on the rear frame and the rear cover.

### BACKGROUND OF THE INVENTION

1. Field of the Invention

The present invention relates to a display device for displaying images.

2. Description of the Related Art

Known display devices are equipped with a backlight unit that directs light onto a back surface of a display panel, such as a liquid crystal television receiver (for example, see Japanese Patent Application Laid-Open Publication No. 2012-249331). A display panel, a backlight, a speaker, and the like, for example, are built in the casing of such a display device. Among these, a speaker is mounted on a speaker mounting structure that is installed in the casing.

The sound quality and sound volume output from a speaker are generally related to the size of the speaker. The tendency is for quality and volume to be higher the larger the speaker is. For this reason, the size of the speaker may be selected as appropriate according to the display device specifications during the design stage of the display device.

However, the speaker mounting structure described above only works with a single size of speaker, which leads to the problem that when the size of the speaker is to be changed, the design of the speaker mounting structure must be changed for the new size of the speaker. Furthermore, molds and the like for forming the casing must be changed when changing the design of the speaker mounting structure, which also creates the problem of increasing the manufacturing cost of the display device.

### SUMMARY OF THE INVENTION

Preferred embodiments of the present invention provide a display device in which speakers of a plurality of size types are capable of being mounted on a back member.

A display device according to one a preferred embodiment of the present invention includes a display panel that displays images, a back member disposed on a back side of the display panel and including an opening, a first mounting member provided on the back member, a second mounting member provided on the back member and disposed on a side opposite from the opening, with the first mounting member being arranged between the opening and the second mounting member, a speaker mounted on either the first mounting member or the second mounting member and including a sound output unit that outputs sound, and a first covering surface provided on the back member, and in which if the size of the speaker is a first size, the speaker is mounted on the first mounting member such that the sound output unit is disposed at the opening, and if the size of the speaker is a second size that is smaller than the first size, then the speaker is mounted on the second mounting member such that the sound output unit faces toward the opening, and the first covering surface covers at least a portion of a first space between the opening and the sound output unit.

According to this preferred embodiment, the first mounting member and the second mounting member are provided on the back member, so speakers of a plurality of size types (for example, two types, large and small) are capable of being mounted on the back member without changing the shape, structure or the like of the back member. For instance, when the display device specifications call for mounting a speaker that has high sound quality and high sound volume characteristics, a speaker of the first size is capable of being mounted on the first mounting member. The sound output unit of the speaker is disposed at the opening, so the sound from the sound output unit passes through the opening and is dispersed directly to the outside of the display device. Meanwhile, when the display device specifications call for mounting a speaker that has low sound quality and low sound volume characteristics, for example, a speaker of a second size that is smaller than the first size is capable of being mounted on the second mounting member. At this time, at least a portion of the entire circumference of a first space between the sound output unit of the speaker and the opening is covered by the first covering surface, so the sound from the sound output unit passes through the opening and is dispersed to the outside of the display device while being reflected by the first covering surface.

For example, the display device according to a preferred embodiment of the present invention preferably is configured such that the first covering surface covers the entire circumference of the first space, and the diameter of the first covering surface expands toward the opening from the sound output unit of the speaker that is mounted on the second mounting member.

In this preferred embodiment, the diameter of the first covering surface expands toward the opening from the sound output unit of the speaker that is mounted on the second mounting member, so when a speaker of the second size is mounted on the second mounting member, degradation of the frequency characteristics is significantly reduced or prevented, and sound from the sound output unit is efficiently conducted to the outside of the display device. Note that the first covering surface may preferably have a trumpet shape, a conical shape, a polygonal pyramidal shape, or the like, for example.

For instance, the display device according to a preferred embodiment of the present invention preferably is configured such that the back member includes a back casing disposed on the back side of the display panel and a cover member that covers a portion of the back casing from the outside, and the speaker is sandwiched between the back casing and the cover member when mounted on either the first mounting member or the second mounting member.

In this preferred embodiment, because the back member includes a back casing and a cover member, the speaker is capable of being mounted on the back member as a result of the speaker being sandwiched between the back casing and the cover member.

For example, the display device according to a preferred embodiment of the present invention preferably also includes a seal member that is interposed between the speaker and the back casing as well as the cover member.

In this preferred embodiment, the seal member is interposed between the speaker and the back casing and cover member, so the space between the speaker and the back casing and cover member is sealed. As a result, sound from the sound output unit is efficiently output outside the display device.

For instance, the display device according to a preferred embodiment of the present invention preferably is configured such that the first mounting member and the second mounting member each include either a protrusion or an indent, the speaker include the other of the protrusion or indent, and the speaker is mounted on either the first mounting member or the second mounting member as a result of the protrusion being inserted into the indent.

In this preferred embodiment, the speaker preferably is mounted on either the first mounting member or the second mounting member by inserting the protrusion into the indent, so the speaker is mounted easily and securely.

For example, the display device according to a preferred embodiment of the present invention preferably is configured such that the display device further includes a third mounting member provided on the back member and disposed on the side opposite from the opening, with the second mounting member being arranged between the opening and the third mounting member, and a second covering surface provided on the back member and disposed on the side opposite from the opening, with a first covering surface being arranged between the opening and the second covering surface, and if the size of the speaker is a third size that is smaller than the second size, then the speaker is mounted on the third mounting member such that the sound output unit faces toward the opening, and the first covering surface and the second covering surface cover at least a portion of a second space between the opening and the sound output unit.

In this preferred embodiment, because the third mounting member is provided on the back member, speakers of a plurality of size types (for example, three types, large, medium, and small) are capable of being mounted on the back member without changing the shape or the like of the back member. When the speaker of the third size is mounted on the third mounting member, at least a portion of an entire circumference of the second space between the sound output unit of the speaker and the opening is covered by the first covering surface and the second covering surface. Consequently, sound from the sound output unit is dispersed outside the display device through the opening while being reflected by the first covering surface and the second covering surface.

For instance, the display device according to a preferred embodiment of the present invention preferably is configured such that the first covering surface and the second covering surface cover the entire circumference of the second space, and the diameter of each of the first covering surface and the second covering surface expands toward the opening from the sound output unit of the speaker that is mounted on the third mounting member.

In this preferred embodiment, the diameter of each of the first covering surface and the second covering surface expands toward the opening from the sound output unit of the speaker that is mounted on the third mounting member. Therefore, when the speaker of the third size is mounted on the third mounting member, degradation of the frequency characteristics is significantly reduced or prevented, and sound from the sound output unit is efficiently conducted to the outside of the display device. Note that the first covering surface and the second covering surface each preferably have a trumpet shape, conical shape, polygonal pyramidal shape, or the like, for example.

For instance, the display device according to a preferred embodiment of the present invention preferably is configured such that the opening is provided at a lower end portion of the back member.

In this preferred embodiment, because the opening is provided at the lower end portion of the back member, the speaker is capable of being mounted on the first mounting member or the like such that the sound output unit faces a bottom of the display unit.

Display devices according to various preferred embodiments of the present invention are configured to mount speakers of a plurality of size types on the back member.

The above and other elements, features, steps, characteristics and advantages of the present invention will become more apparent from the following detailed description of the preferred embodiments with reference to the attached drawings.

### BRIEF DESCRIPTION OF THE DRAWINGS

FIG. 1 is a perspective view showing a front side of a display device according to a first preferred embodiment of the present invention.

FIG. 2 is a perspective view showing a back side of the display device according to the first preferred embodiment of the present invention.

FIG. 3 is a perspective view showing the back side of the display device according to the first preferred embodiment of the present invention in a state in which a rear cover is removed from a rear frame.

FIG. 4 is a perspective view of key portions showing in an enlarged manner the configuration of one of the first speakers of FIG. 3 and its periphery.

FIG. 5 is a sectional perspective view of key portions showing a state before the first speaker is sandwiched between the rear frame and the rear cover.

FIG. 6 is a sectional perspective view of key portions showing an enlarged portion of the rear cover.

FIG. 7 is a sectional perspective view of key portions showing a state in which the first speaker is sandwiched between the rear frame and the rear cover.

FIG. 8 is a sectional view along line A-A in FIG. 7 showing a state in which the first speaker is sandwiched between the rear frame and the rear cover.

FIG. 9 is a perspective view of key portions showing the configuration of a second speaker and its periphery in an enlarged manner.

FIG. 10 is a sectional view showing a state in which the second speaker is sandwiched between the rear frame and the rear cover.

FIG. 11 is a perspective view of key portions showing a state before a first speaker of the display device according to a second preferred embodiment of the present invention is sandwiched between the rear frame and the rear cover.

FIG. 12 is a perspective view of key portions showing a state before a third speaker of the display device according to a third preferred embodiment of the present invention is sandwiched between the rear frame and the rear cover.

FIG. 13 is a sectional view showing a state in which the third speaker has been sandwiched between the rear frame and the rear cover.

### DETAILED DESCRIPTION OF PREFERRED EMBODIMENTS

Preferred embodiments of the present invention will be described in detail below using drawings. Note that each of the preferred embodiments to be described below represents a preferred concrete example of the present invention. The numerical values, shapes, materials, constituent elements, the disposed positions and connection preferred embodiments of the constituent elements, and so forth indicated in the preferred embodiments below are just examples and do not limit the present invention. The present invention is specified by the scope of the claims. The constituent elements, the disposed positions, the connections, arrangements of the constituent elements, and so forth indicated in the preferred embodiments below are just examples and do not limit the present invention.

### First Preferred Embodiment

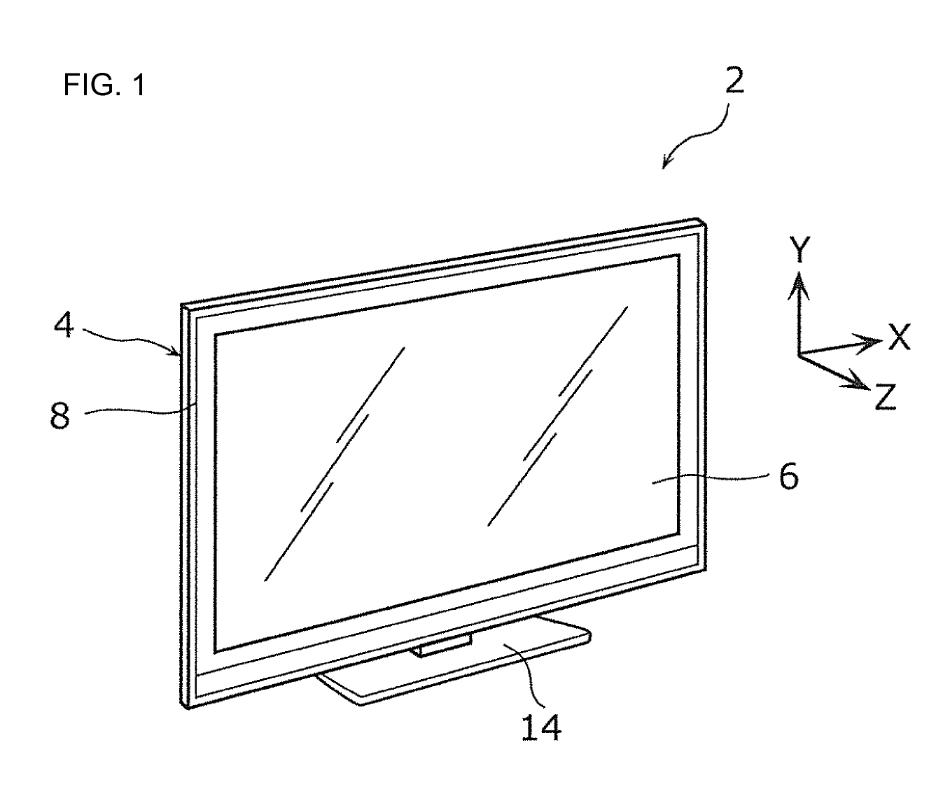

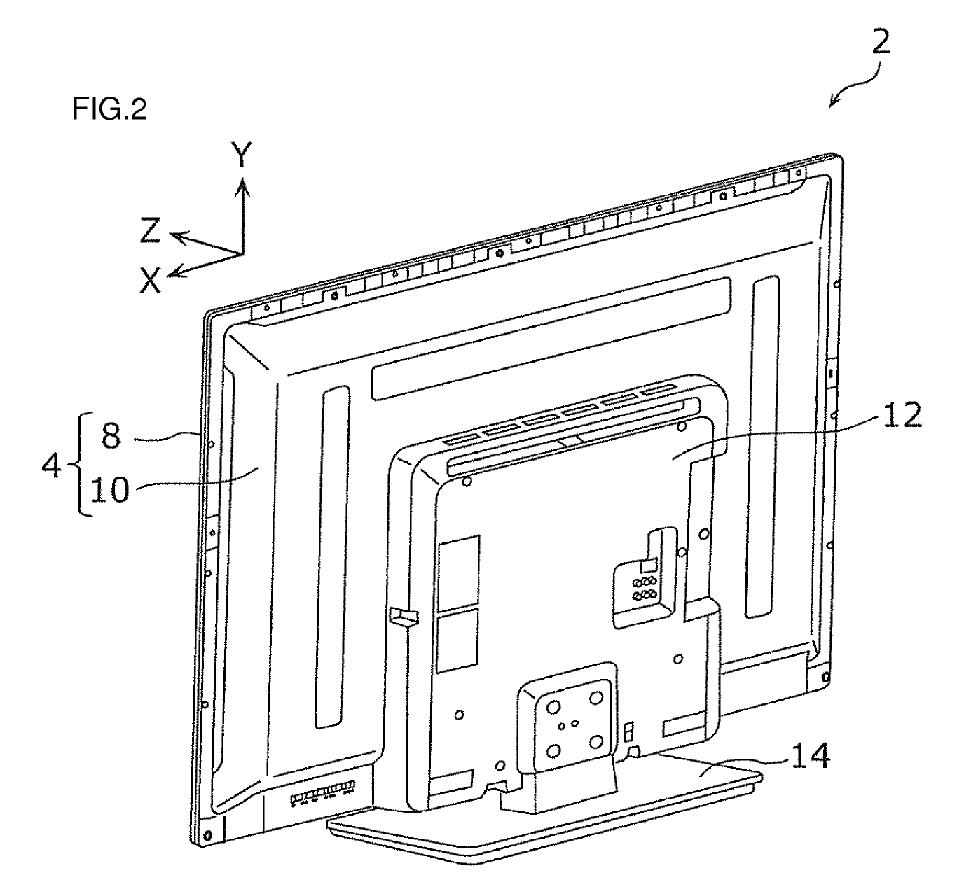

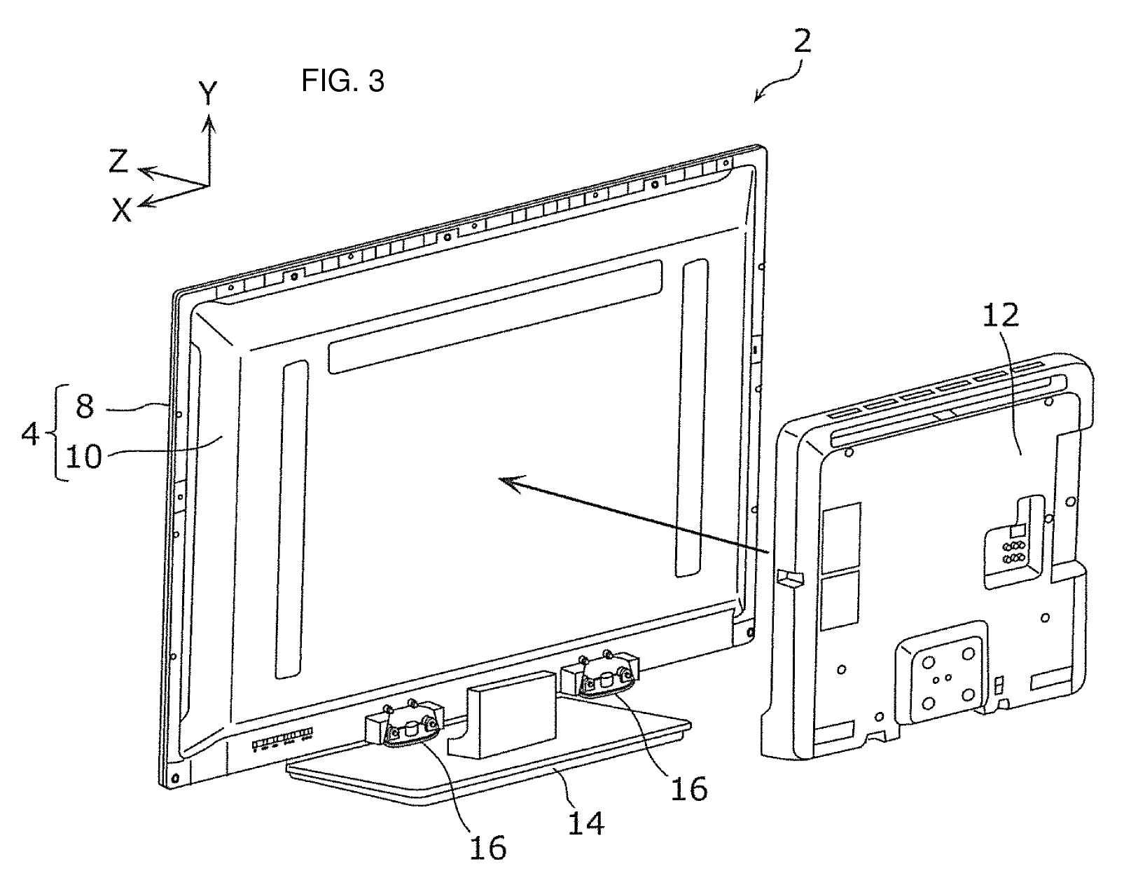

First, the overall configuration of the display device according to the first preferred embodiment will be described with reference to FIGS. 1 through 3. FIG. 1 is a perspective view showing the front side of the display device according to the first preferred embodiment. FIG. 2 is a perspective view showing the back side of the display device according to the first preferred embodiment. FIG. 3 is a perspective view showing the back side of the display device according to the first preferred embodiment in a state in which the rear cover is removed from the rear frame.

As shown in FIG. 1, the display device 2 is equipped with a casing 4, a liquid crystal panel 6 (constituting the display panel) installed within the casing 4, and a backlight unit (not shown). The display device 2 of the present preferred embodiment preferably is a liquid crystal television receiver that is equipped with a downlight-type backlight unit, for example.

The casing 4 preferably includes a front cabinet 8 and a rear frame 10 (constituting each of the back member and the back casing) attached to each other as shown in FIGS. 1 and 2.

The front cabinet 8 is disposed on the front side of the liquid crystal panel 6. The front cabinet 8 is configured in the shape of a frame and covers the outer peripheral portion of the liquid crystal panel 6. Note that the front cabinet 8 preferably is made of plastic, for example.

The rear frame 10 is disposed on the back side of the liquid crystal panel 6. The rear frame 10 preferably has a shape that bulges out slightly on the opposite side of the liquid crystal panel 6 and covers the entire back surface of the liquid crystal panel 6, for example. The backlight unit is disposed between the liquid crystal panel 6 and the rear frame 10. Note that the rear frame 10 preferably includes a metal plate, for example.

A rear cover 12 (constituting the cover member) is mounted on the outer surface of the rear frame 10 (constituting the back member). The rear cover 12 is configured to externally cover the power supply board and the like (not shown) mounted on the outer surface of the rear frame 10. A stand 14 configured to support the casing 4 from below is mounted at the lower end portion of the rear frame 10. Note that the rear cover 12 and the stand 14 are each preferably made of plastic, for example.

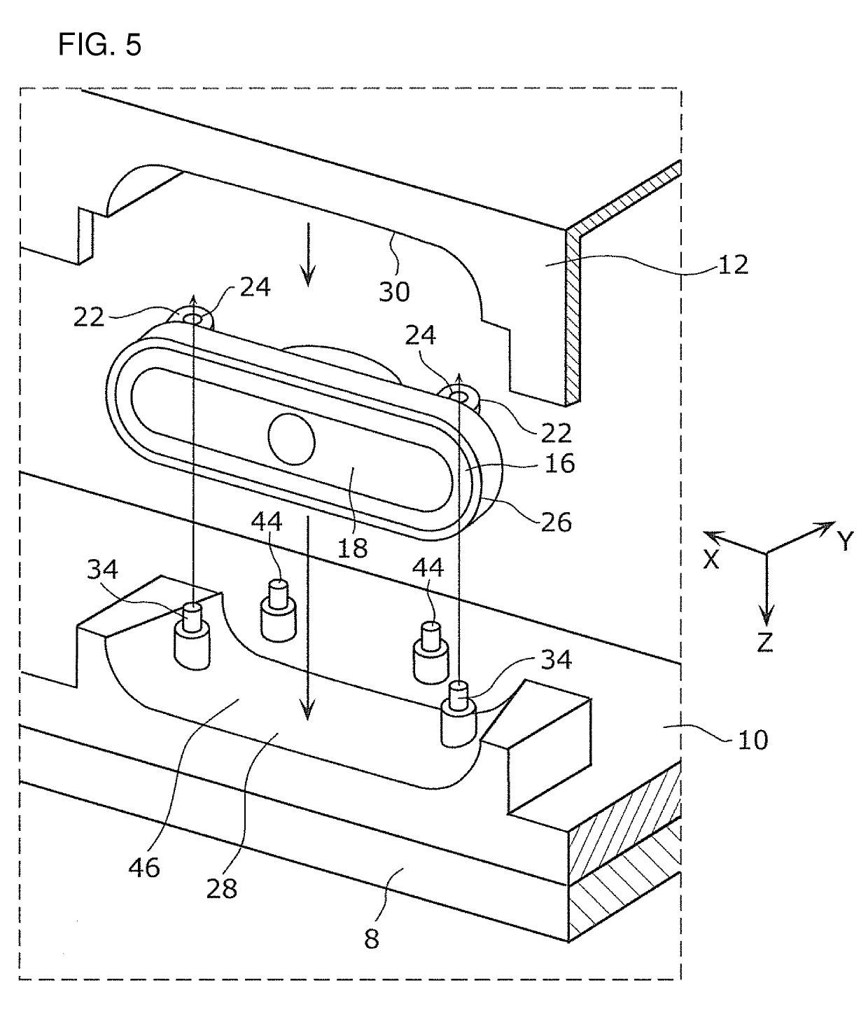

As shown in FIG. 3, a pair of first speakers 16 having a first size (each of the pair of first speakers 16 constitutes the speaker) are mounted on the lower end portion of the rear frame 10. Note that, in the specification of the present application, the size of the speakers refers to the horizontal width, height, and the like of each speaker. The pair of first speakers 16 are each covered by the rear cover 12. Each of the pair of first speakers 16 has a sound output unit 18 that outputs sound (see FIG. 5 to be described below). Note that the sound output unit 18 preferably includes a center cap, diaphragm, and the like, for example. The pair of first speakers 16 are sandwiched between the rear frame 10 and the rear cover 12 such that the respective sound output units 18 thereof face toward the bottom of the display unit 2. Accordingly, the sound from the sound output units 18 is output toward the bottom of the display unit 2 (that is, toward the surface on which the stand 14 is installed).

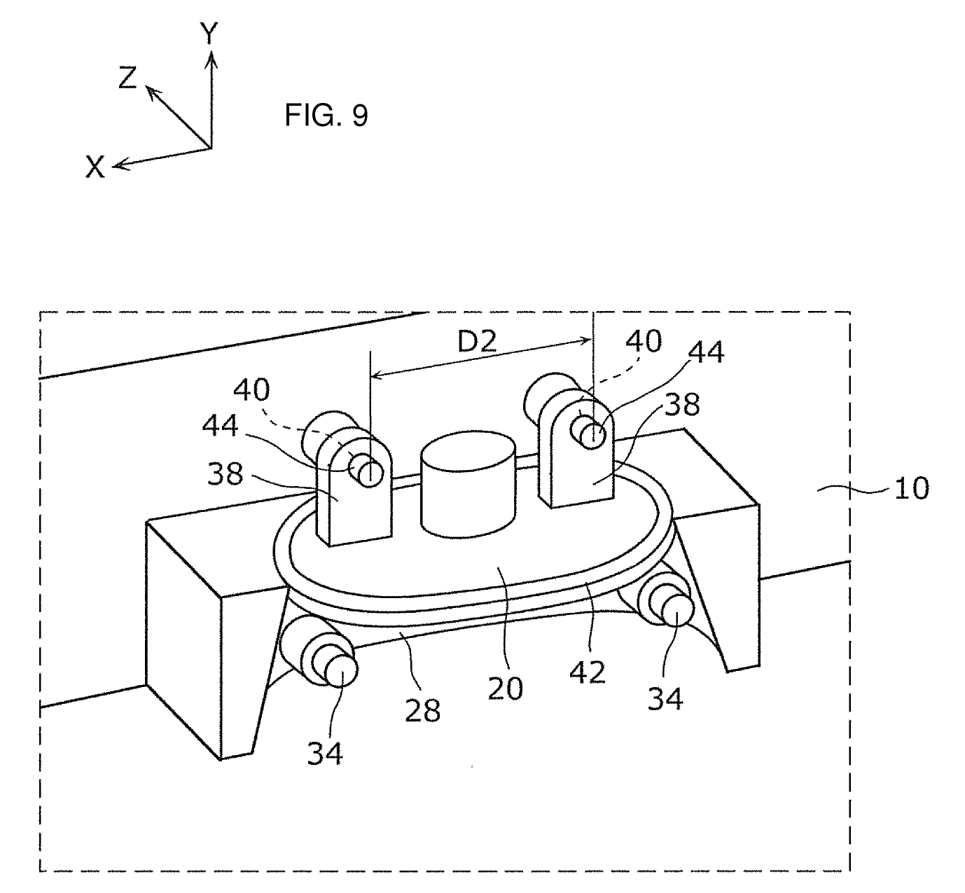

A feature of the display device 2 of the present preferred embodiment is that speakers of a plurality of size types are capable of being mounted on the rear frame 10 and the rear cover 12. In concrete terms, either a pair of first speakers 16 having a first size or a pair of second speakers 20 having a second size that is smaller than the first size (each of the pair of second speakers 20 constitutes the speaker) (see FIG. 9 to be described later) are capable of being mounted on the rear frame 10 and the rear cover 12. A description will be given below of the mounting structure configured to mount the first speakers 16 and the second speakers 20 that have different sizes on the rear frame 10 and the rear cover 12.

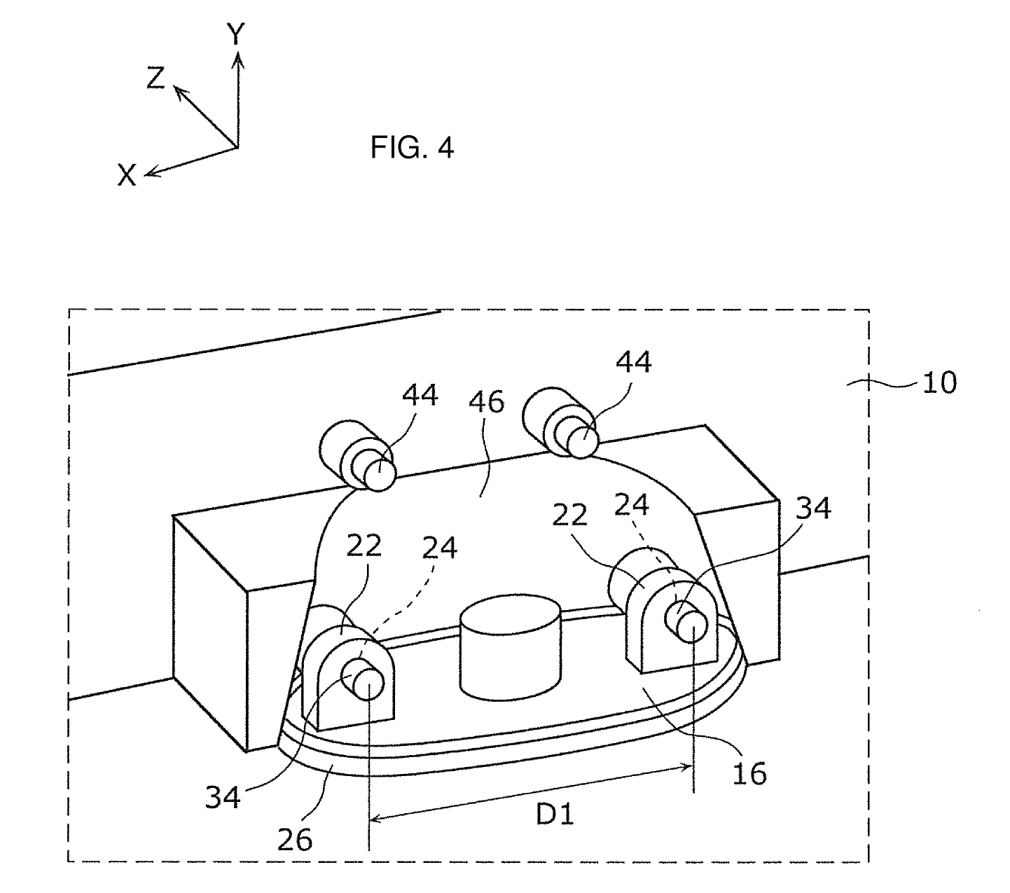

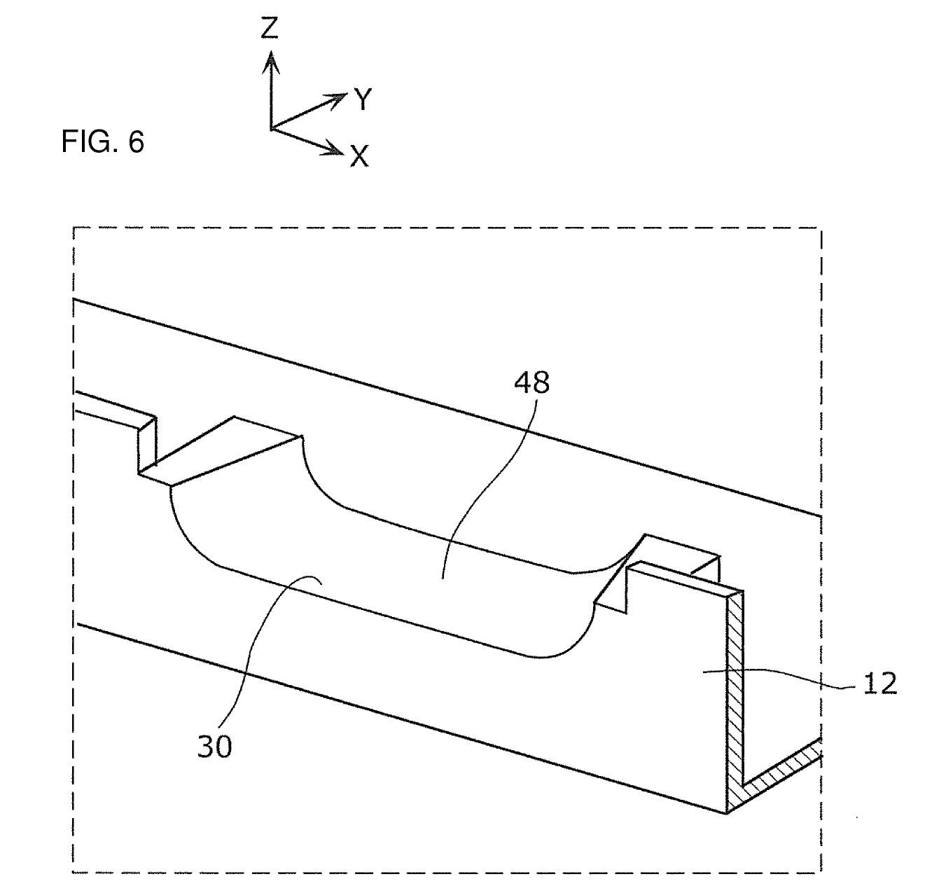

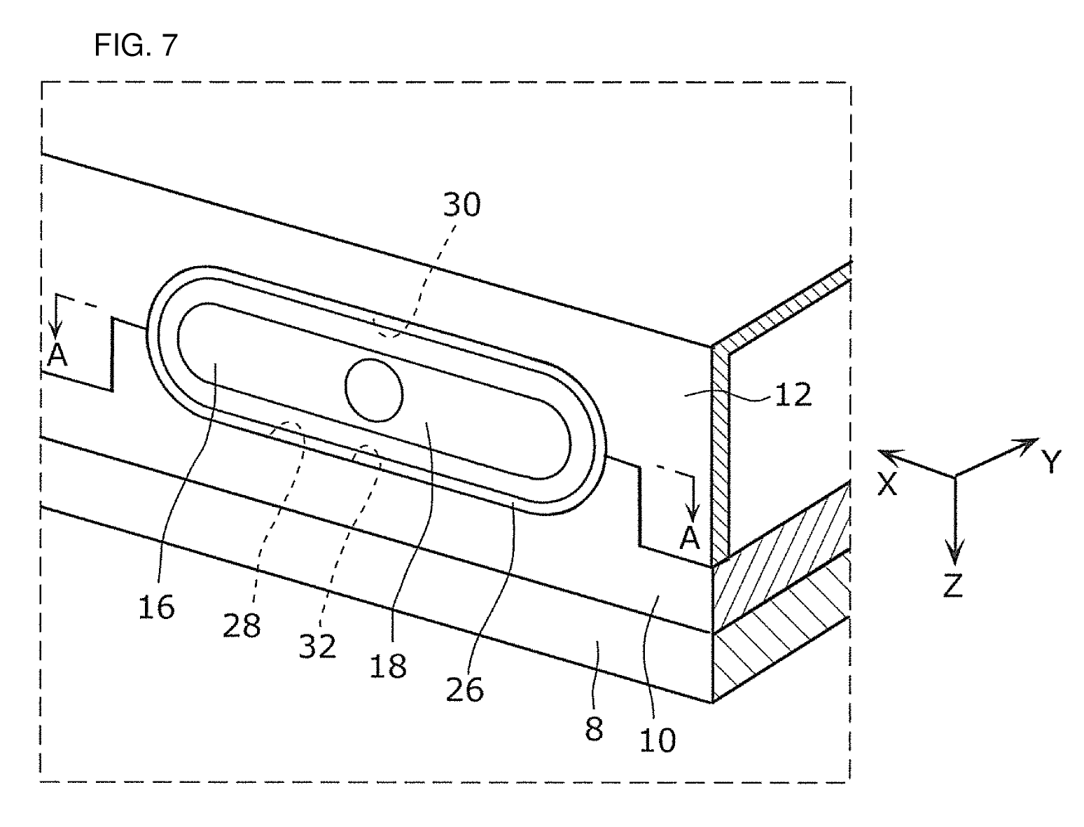

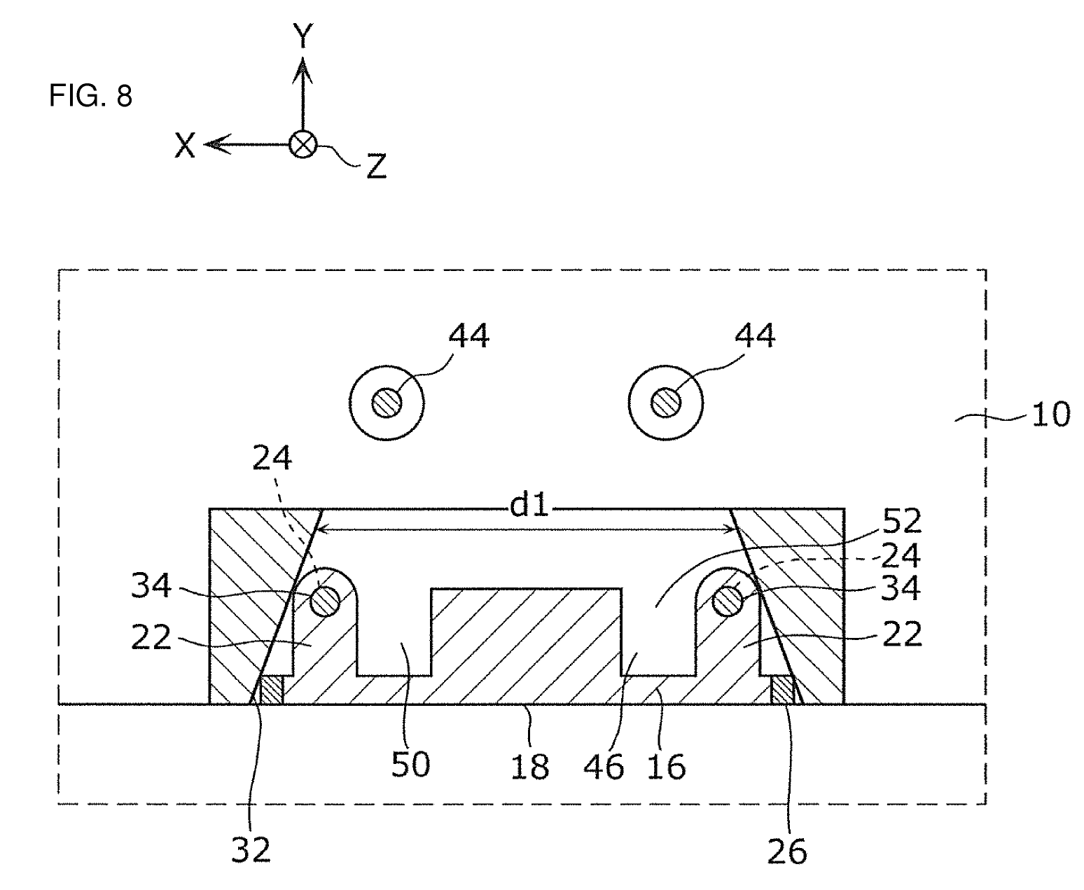

First, the mounting structure configured to mount each of the pair of first speakers 16 on the rear frame 10 and the rear cover 12 will be described with reference to FIGS. 4 through 8. FIG. 4 is a perspective view of key portions showing in an enlarged manner the configuration of one of the first speakers of FIG. 3 and its periphery. FIG. 5 is a sectional perspective view of key portions showing a state before the first speaker is sandwiched between the rear frame and the rear cover. FIG. 6 is a sectional perspective view of key portions showing an enlarged portion of the rear cover. FIG. 7 is a sectional perspective view of key portions showing a state in which the first speaker is sandwiched between the rear frame and the rear cover. FIG. 8 is a sectional view along line A-A in FIG. 7 showing a state in which the first speaker has been sandwiched between the rear frame and the rear cover.

As shown in FIG. 4, a pair of brackets 22 are provided on the surface of each of the first speakers 16 on the side opposite from the sound output unit 18. Each of the pair of brackets 22 is provided with an indent 24. The indents 24 preferably are circular or substantially circular holes that pass through the brackets 22 in the direction of thickness thereof, for example. The pair of indents 24 are disposed so as to be separated by an interval D1. Furthermore, a ring-shaped seal member 26 is attached to the outer circumferential portion of the first speaker 16. The seal member 26 is preferably made of a cushion material, rubber material, or the like, for example.

As shown in FIG. 5, cutouts 28 with indented shapes are provided in the outer surface of the rear frame 10 at the lower end portion thereof. Moreover, as shown in FIGS. 5 and 6, cutouts 30 with indented shapes are provided in the inner surface of the rear cover 12 at the lower end portion thereof. As shown in FIG. 7, in a state in which the rear frame 10 is mounted on the rear cover 12, openings 32 are provided in the undersurfaces of the rear frame 10 and rear cover 12 (that is, at the lower end portion of the back member) as a result of the cutouts 28 and 30 being respectively combined with each other. These openings 32 have a shape that corresponds to the external shape of the first speakers 16.

A pair of cylindrical protrusions 34 (constituting the first mounting member) are provided for each of the first speakers 16 on the outer surface of the rear frame 10 at the lower end portion thereof as shown in FIGS. 4 and 5. The pair of protrusions 34 are each disposed in the vicinity of the corresponding cutout 28 and extend toward the rear cover 12. The pair of protrusions 34 are disposed so as to be separated by the interval D1. That is, the interval at which the pair of protrusions 34 are disposed is set to a size that corresponds to the disposition interval of the pair of indents 24 of the first speaker 16.

When each of the first speakers 16 is to be mounted on the rear frame 10 and the rear cover 12, the pair of protrusions 34 are first respectively inserted into the pair of indents 24 of the first speaker 16 in a state in which the rear cover 12 is removed from the rear frame 10 as shown in FIGS. 4 and 5. The first speaker 16 is thus positioned with respect to the rear frame 10. At this time, a portion of the outer circumference of the first speaker 16 is disposed at the corresponding cutout 28 of the rear frame 10 via the seal member 26. In addition, the other portion of the outer circumference of the first speaker 16 is disposed at the cutout 30 of the rear cover 12 via the seal member 26 as a result of the rear cover 12 being mounted on the rear frame 10 as shown in FIG. 7. The outer circumferential portion of the first speaker 16 is thus sandwiched between the cutouts 28 and 30, and the sound output unit 18 is exposed to the outside through the opening 32 as shown in FIGS. 7 and 8. Thus, the first speaker 16 is mounted on the rear frame 10 and the rear cover 12 by being sandwiched between the rear frame 10 and the rear cover 12.

Note that the seal member 26 is interposed between the first speaker 16 and the rear frame 10 and rear cover 12, so the gap between the first speaker 16 and the rear frame 10 and rear cover 12 is sealed.

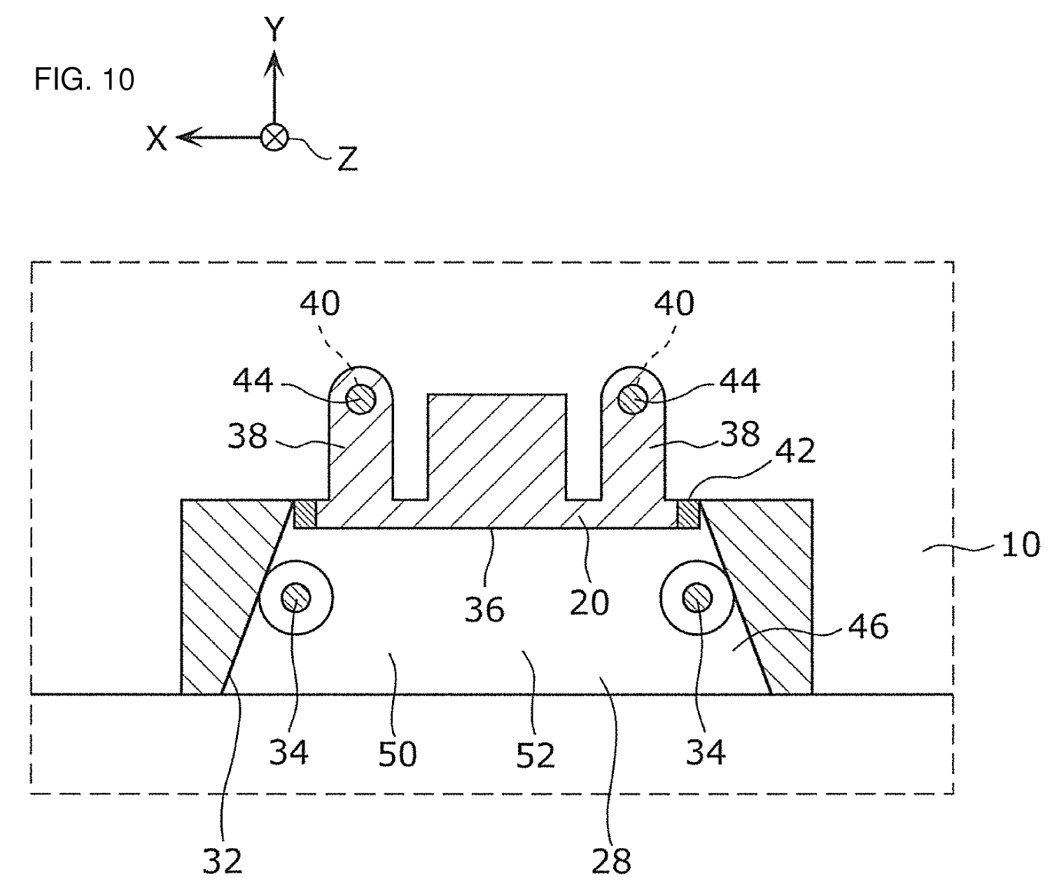

Next, the mounting structure configured to mount each of the pair of second speakers 20 on the rear frame 10 and the rear cover 12 will be described with reference to FIGS. 9 and 10 as well. FIG. 9 is a perspective view of key portions showing the configuration of a second speaker and its periphery in an enlarged manner. FIG. 10 is a sectional view showing a state in which the second speaker is sandwiched between the rear frame and the rear cover.

As was described above, the size of the second speakers 20 is the second size which is smaller than the first size of the first speakers 16. Each second speaker 20 includes a sound output unit 36 that outputs sound as shown in FIG. 10. A pair of brackets 38 are provided on the surface of the second speaker 20 on the side opposite from the sound output unit 36 as shown in FIGS. 9 and 10. An indent 40 is provided in each of the pair of brackets 38. The indents 40 preferably are circular holes that pass through the brackets 38 in the direction of thickness thereof, for example. The pair of indents 40 are disposed so as to be separated by an interval D2. Note that the interval D2 at which the pair of indents 40 are disposed is smaller than the interval D1 at which the pair of indents 24 are disposed. Furthermore, a ring-shaped seal member 42 is attached to the outer circumferential portion of the second speaker 20. The seal member 42 is preferably made of a cushion material, rubber material, or the like, for example.

As shown in FIGS. 4, 5, 8, and 9, a pair of cylindrical protrusions 44 (constituting the second mounting member) are provided for each of the second speakers 20 on the outer surface of the rear frame 10 at the lower end portion thereof. The pair of protrusions 44 are each disposed on the side opposite from the opening 32, with the pair of protrusions 34 being arranged between the opening 32 and the protrusions 44 and extend toward the rear cover 12. The pair of protrusions 44 are disposed so as to be separated by the interval D2. That is, the interval at which the pair of protrusions 44 are disposed is set to a size that corresponds to the disposition interval of the pair of indents 40 of the second speaker 20.

A curved concave portion 46 is provided for each speaker in the outer surface of the rear frame 10 at the lower end portion thereof as shown in FIGS. 4 and 5. The cutout 28 described above is provided at one end portion of the concave portion 46. The other end portion of the concave portion 46 is disposed between the pair of protrusions 34 and the pair of protrusions 44. Moreover, as shown in FIG. 6, a curved concave portion 48 is provided in the inner surface of the rear cover 12 at the lower end portion thereof. This concave portion 48 is disposed so as to face the concave portion 46 of the rear frame 10. The cutout 30 is provided at one end portion of the concave portion 48.

As shown in FIGS. 8 and 10, in a state in which the rear cover 12 is mounted on the rear frame 10, a curved first covering surface 50 is provided as a result of the concave portions 46 and 48 being combined with each other. The opening 32 is provided at one end portion of the first covering surface 50. In addition, the other end portion of the first covering surface 50 is disposed between the pair of protrusions 34 and the pair of protrusions 44 and has a shape that corresponds to the external shape of the second speaker 20. Furthermore, the diameter d1 of the first covering surface 50 expands from the second end portion toward the first end portion (that is, from the sound output unit 36 of the second speaker 20 toward the opening 32). In other words, the shape of the first covering surface 50 preferably is a so-called trumpet shape, for example.

When each of the second speakers 20 is to be mounted on the rear frame 10 and the rear cover 12, the pair of protrusions 44 are first respectively inserted into the pair of indents 40 of the second speaker 20 in a state in which the rear cover 12 is removed from the rear frame 10 as shown in FIG. 9. The second speaker 20 is thus positioned with respect to the rear frame 10 and disposed such that the sound output unit 36 thereof faces toward the opening 32. At this time, a portion of the outer circumference of the second speaker 20 is disposed at the concave portion 46 of the rear frame 10 via the seal member 42. Furthermore, the other portion of the outer circumference of the second speaker 20 is disposed at the concave portion 48 of the rear cover 12 via the seal member 42 as a result of the rear cover 12 being mounted on the rear frame 10. The outer circumferential portion of the second speaker 20 is thus sandwiched between the concave portions 46 and 48, and as shown in FIG. 10, the outer circumferential portion of the second speaker 20 is disposed at the second end portion of the first covering surface 50. Note that the entire circumference of a first space 52 between the sound output unit 36 of the second speaker 20 and the opening 32 is covered by the first covering surface 50. Thus, the second speaker 20 is mounted on the rear frame 10 and the rear cover 12 by being sandwiched between the rear frame 10 and the rear cover 12.

Note that because the seal member 42 is interposed between the second speaker 20 and the rear frame 10 and rear cover 12, the gap between the second speaker 20 and the rear frame 10 and rear cover 12 is sealed.

Next, the advantageous effects achieved by the display device 2 of the present preferred embodiment will be described. As was described above, the rear frame 10 is provided with the pair of protrusions 34 that define and serve as the first mounting member and the pair of protrusions 44 that define and serve as the second mounting member for each speaker. Consequently, the first speakers 16 and second speakers 20 of a plurality of size types (in the present preferred embodiment, two sizes, large and small, for example) are capable of being mounted on the rear frame 10 and the rear cover 12 without changing the respective shapes, structure, arrangement or the like of the rear frame 10 and the rear cover 12.

For example, in the case of specifications that call for mounting a speaker having high sound quality and high sound volume characteristics under the specifications of the display device 2, a first speaker 16 of the first size are capable of being mounted on the pair of protrusions 34. Note that because the sound output unit 18 of the first speaker 16 is disposed at the opening 32, sound from the sound output unit 18 is dispersed directly outside of the display device 2 through the opening 32.

On the other hand, in the case of specifications that call for mounting a speaker having low sound quality and low sound volume characteristics under the specifications of the display device 2, for example, a second speaker 20 of the second size are capable of being mounted on the pair of protrusions 44. Note that because the entire circumference of the first space 52 between the sound output unit 36 of the second speaker 20 and the opening 32 is covered by the first covering surface 50, sound from the sound output unit 36 is dispersed outside of the display device 2 through the opening 32 while being reflected by the first covering surface 50. At this time, because the shape of the first covering surface 50 preferably is a so-called trumpet shape, degradation of frequency characteristics is significantly reduced or prevented, and sound from the sound output unit 36 is guided efficiently to the outside of the display device 2.

### Second Preferred Embodiment

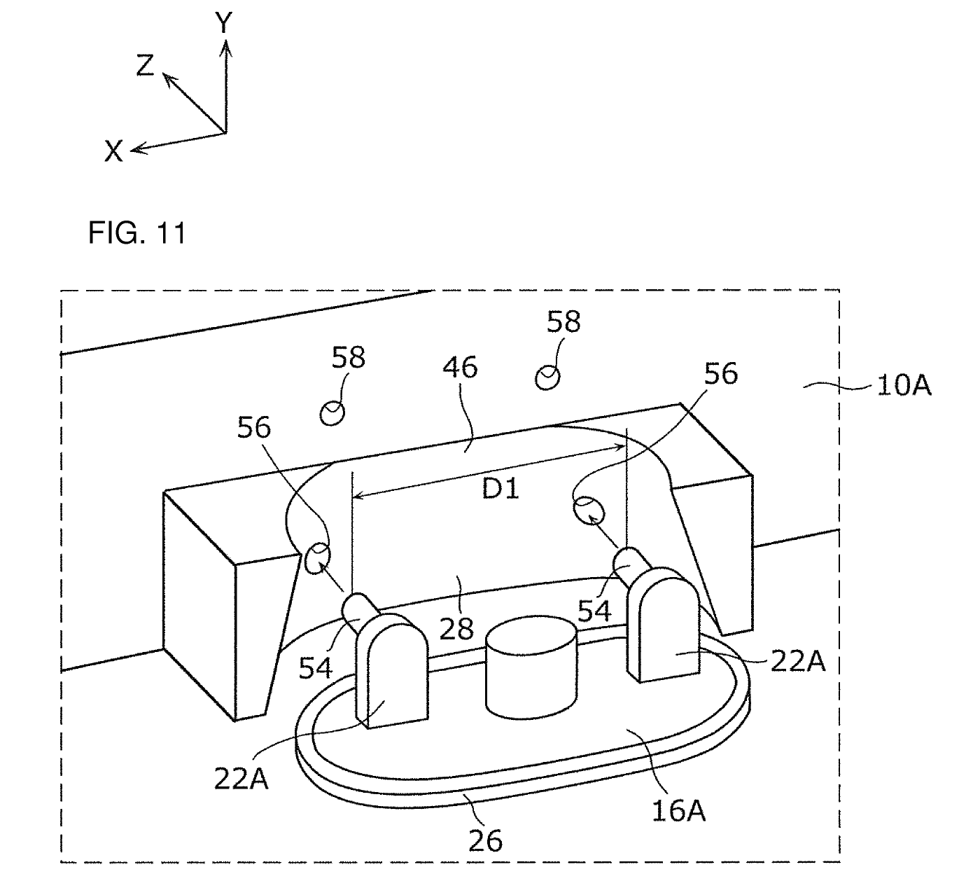

Next, the configuration of the display device according to a second preferred embodiment of the present invention will be described with reference to FIG. 11. FIG. 11 is a perspective view of key portions showing a state before a first speaker of the display device according to the second preferred embodiment is sandwiched between the rear frame and the rear cover. Note that in each of the following preferred embodiments, the same symbols are assigned to the constituent elements that are the same as in the first preferred embodiment above, and the description thereof will be omitted.

As shown in FIG. 11, in the display device of the present preferred embodiment, cylindrical protrusions 54 are respectively provided on a pair of brackets 22A of a first speaker 16A. The pair of protrusions 54 are disposed so as to be separated by the interval D1. Moreover, a pair of circular indents 56 (constituting the first mounting member) are provided for each first speaker in the outer surface of the rear frame 10A at the lower end portion thereof. The pair of indents 56 are disposed so as to be separated by the interval D1. That is, the interval at which the pair of indents 56 are disposed is set to a size that corresponds to the disposition interval of the pair of protrusions 54 of the first speaker 16A.

The first speaker 16A are capable of being mounted on the rear frame 10A and the rear cover 12 (see FIG. 5, etc.) as a result of the pair of protrusions 54 of the first speaker 16A being respectively inserted into the pair of indents 56 in a state in which the rear cover 12 is removed from the rear frame 10A.

Note that, just as in the first speaker 16A, a protrusion is also provided on each of a pair of brackets of a second speaker (not shown). A pair of indents 58 (constituting the second mounting member) are provided for each second speaker in the outer surface of the rear frame 10A at the lower end portion thereof. Each of the pair of indents 58 is disposed on the side opposite from the opening 32 (see FIG. 7, etc.), with the pair of indents 56 being arranged between the opening 32 and the indents 58. The disposition interval of the pair of indents 58 is set to a size that corresponds to the disposition interval of the pair of protrusions of the second speaker.

The second speaker 20 is capable of being mounted on the rear frame 10A and the rear cover 12 as a result of the pair of protrusions of the second speaker being respectively inserted into the pair of indents 58 in a state in which the rear cover 12 is removed from the rear frame 10A.

### Third Preferred Embodiment

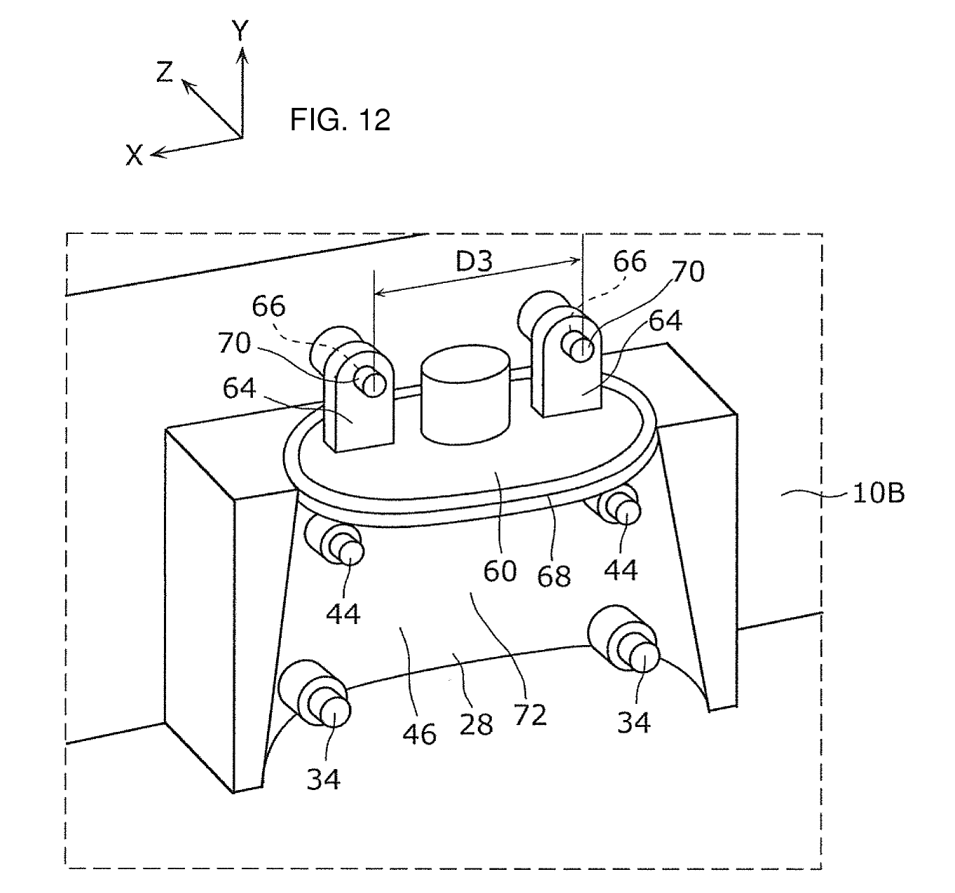

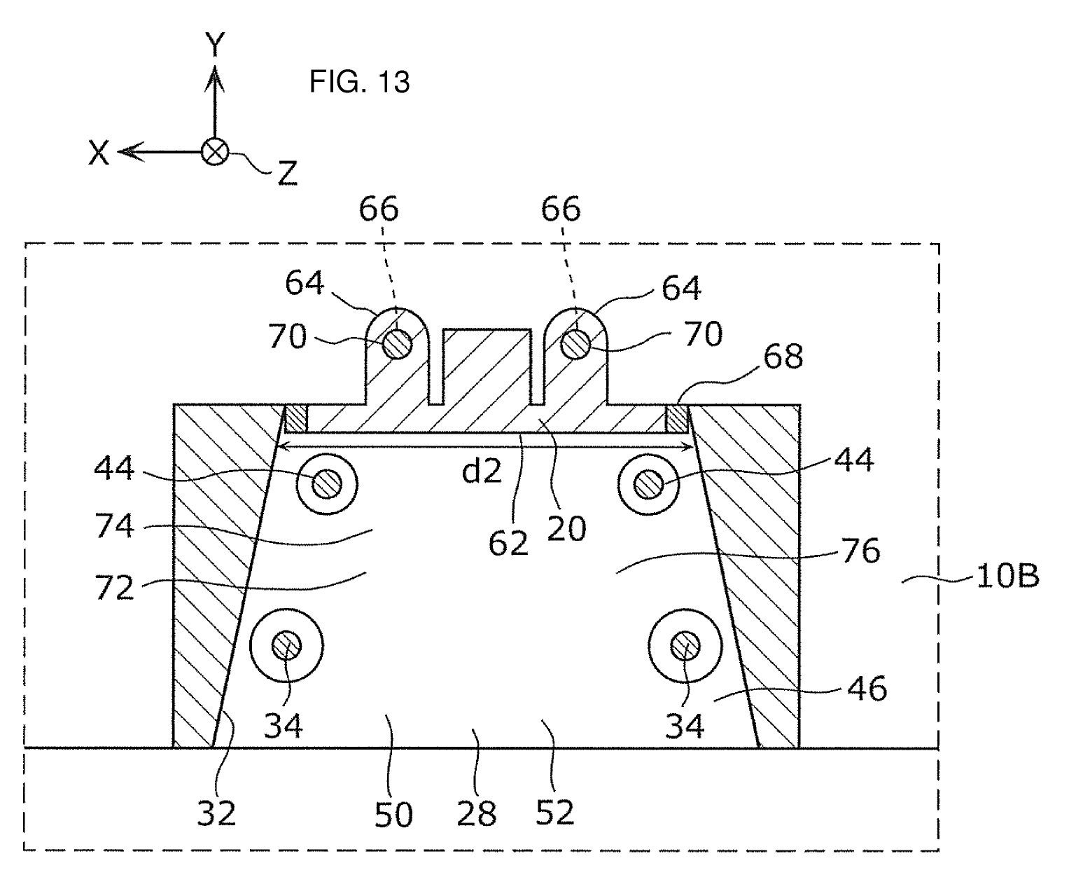

Next, the configuration of the display device according to a third preferred embodiment of the present invention will be described with reference to FIGS. 12 and 13. FIG. 12 is a perspective view of key portions showing a state before a third speaker of the display device according to the third preferred embodiment is sandwiched between the rear frame and the rear cover. FIG. 13 is a sectional view showing a state in which the third speaker is sandwiched between the rear frame and the rear cover.

As shown in FIGS. 12 and 13, in the display device of the present preferred embodiment, any one of three size types of speaker, i.e., large, medium, and small,—in concrete terms, first speakers 16, second speakers 20, and third speakers 60 (constituting the speaker)—are capable of being mounted on the rear frame 10B and the rear cover (not shown).

The third speakers 60 have a third size that is even smaller than the second size of the second speakers 20. Each of the third speaker 60 has a sound output unit 62 configured to output sound. A pair of brackets 64 are provided on the surface of each of the third speakers 60 on the side opposite from the sound output unit 62. An indent 66 is provided in each of the pair of brackets 64. The indents 66 preferably are circular or substantially circular holes that pass through the brackets 64 in the direction of thickness thereof, for example. The pair of indents 66 are disposed so as to be separated by an interval D3. Note that the interval D3 at which the pair of indents 66 are disposed is smaller than the interval D2 at which the pair of indents 40 are disposed. In addition, a ring-shaped seal member 68 is attached to the outer circumferential portion of the third speaker 60. The seal member 68 is preferably made of a cushion material, rubber material, or the like, for example.

As shown in FIGS. 12 and 13, a pair of cylindrical protrusions 70 (constituting the third mounting member) are provided for each of the third speakers on the outer surface of the rear frame 10B at the lower end portion thereof. The pair of protrusions 70 are each disposed on the side opposite from the opening 32, with the pair of protrusions 44 being arranged between the opening 32 and the protrusions 70 and extend toward the rear cover. The pair of protrusions 70 are disposed so as to be separated by the interval D3. That is, the disposition interval of the pair of protrusions 70 is set to a size that corresponds to the disposition interval of the pair of indents 66 of the third speaker 60.

A curved concave portion 72 is provided for each of the third speakers in the outer surface of the rear frame 10B at the lower end portion thereof. The concave portion 72 is configured in a continuous manner with the concave portion 46, and one end portion thereof is disposed between the pair of protrusions 44 and the pair of protrusions 70. Note that although this is not shown, curved concave portions that are disposed so as to face the concave portions 72 of the rear frame 10B preferably are provided in the inner surface of the rear cover at the lower end portion thereof.

As shown in FIG. 13, in a state in which the rear cover is mounted on the rear frame 10B, a curved second covering surface 74 is provided as a result of a concave portion 72 of the rear frame 10B and the corresponding concave portion of the rear cover being combined with each other. The second covering surface 74 is configured continuously with the first covering surface 50 and disposed on the side opposite from the opening 32, with the first covering surface 50 being arranged between the opening 32 and the second covering surface 74. One end portion of the second covering surface 74 is disposed between the pair of protrusions 44 and the pair of protrusions 70 and has a shape that corresponds to the external shape of the third speaker 60. Furthermore, the diameter d2 of the second covering surface 74 expands from this one end portion toward the other end portion (that is, from the sound output unit 62 of the third speaker 60 toward the opening 32). In other words, the shape of the second covering surface 74 preferably is a so-called trumpet shape.

When each of the third speakers 60 is to be mounted on the rear frame 10B and the rear cover, the pair of protrusions 70 are first respectively inserted into the pair of indents 66 of the third speaker 60 in a state in which the rear cover is removed from the rear frame 10B. The third speaker 60 is thus positioned with respect to the rear frame 10B and disposed such that the sound output unit 62 thereof faces toward the opening 32. Moreover, as a result of the rear cover being mounted on the rear frame 10B, the outer circumferential portion of the third speaker 60 is sandwiched between the corresponding concave portion 72 of the rear frame 10B and the corresponding concave portion of the rear cover, and as shown in FIG. 13, the outer circumferential portion of the third speaker 60 is disposed at the first end portion of the second covering surface 74. Note that the entire circumference of a second space 76 between the sound output unit 62 of the third speaker 60 and the opening 32 is covered by the first covering surface 50 and the second covering surface 74. Thus, the third speaker 60 is mounted on the rear frame 10B and the rear cover by being sandwiched between the rear frame 10B and the rear cover.

Note that because the seal member 68 is interposed between the third speaker 60 and the rear frame 10B and rear cover, the gap between the third speaker 60 and the rear frame 10B and rear cover is sealed.

As was described above, a pair of protrusions 70 that define and serve as the third mounting member are provided for each of the third speakers on the rear frame 10B of the present preferred embodiment in addition to the pair of protrusions 34 that serve as the first mounting member and the pair of protrusions 44 that serve as the second mounting member. Consequently, the first speakers 16, the second speakers 20, and the third speakers 60 of three types of size, i.e., large, medium, and small, are capable of being mounted on the rear frame 10B and the rear cover without changing the respective shapes or the like of the rear frame 10B and the rear cover.

For example, in the case of specifications that call for mounting a speaker having high sound quality and high sound volume characteristics under the specifications of the display device, a first speaker 16 of the first size (see FIG. 4, etc.) is capable of being mounted on the pair of protrusions 34.

Meanwhile, in the case of specifications that call for mounting a speaker having medium sound quality and medium sound volume characteristics under the specifications of the display device, for example, a second speaker 20 of the second size (see FIG. 9, etc.) is capable of being mounted on the pair of protrusions 44.

In addition, in the case of specifications that call for mounting a speaker having low sound quality and low sound volume characteristics under the specifications of the display device, for example, a third speaker 60 of a third size is capable of being mounted on the pair of protrusions 70. Note that because the entire circumference of the second space 76 between the sound output unit 62 of the third speaker 60 and the opening 32 is covered by the first covering surface 50 and the second covering surface 74, sound from the sound output unit 62 is dispersed outside of the display device through the opening 32 while being reflected by the first covering surface 50 and the second covering surface 74. In this case, because the shape of the second covering surface 74 is preferably a so-called trumpet shape, degradation of frequency characteristics is significantly reduced or prevented, and sound from the sound output unit 62 is guided efficiently to the outside of the display device.

The display devices according to the first, second and third preferred embodiments of the present invention were described above, but the present invention is in no way limited to these preferred embodiments. For instance, it is also possible to combine each of the preferred embodiments or various features thereof.

In each of the preferred embodiments, a case was described in which the display device preferably is a liquid crystal television receiver, but the display device may also be a liquid crystal monitor or the like for a personal computer, for example, besides a liquid crystal television receiver.

In each of the preferred embodiments, the first covering surface and the second covering surface preferably are each curved, but the shape is not limited to this. For instance, they can also be formed in the shape of a polyhedron having a plurality of flat surfaces. In this case, each of the first covering surface and the second covering surface preferably have a polygonal pyramid shape, for example.

In each of the preferred embodiments, the first covering surface and the second covering surface are each preferably configured in the shape of a trumpet, but the shape is not limited to this. For example, the first covering surface and the second covering surface can also each be configured in a conical shape.

In the third preferred embodiment, the first covering surface and the second covering surface are each configured in the shape of a trumpet, but the shape is not limited to this. For instance, the first covering surface and the second covering surface can also each be configured in the shape of circular cylinders with respectively different diameters.

In the first and second preferred embodiments, the first covering surface preferably covered the entire circumference of the first space. However, the present invention is not limited to this, and it is also be possible to have the first covering surface cover a portion of the entire circumference of the first space. In this case, indents can be provided only in the rear frame or in the rear cover. Similarly, in the third preferred embodiment, the first covering surface and the second covering surface preferably covered the entire circumference of the second space, but the present invention is not limited to this, they may also be designed to cover a portion of the entire circumference of the second space.

In the first and third preferred embodiments, a pair of protrusions defining the first mounting member and the second mounting member are preferably provided on the rear frame, but they can also be provided on the rear cover. Similarly, in the second preferred embodiment, a pair of indents defining the first mounting member and the second mounting member are provided in the rear frame, but they can also be provided in the rear cover.

Preferred embodiments of the present invention preferably are applied as a display device or the like that displays images.

While preferred embodiments of the present invention have been described above, it is to be understood that variations and modifications will be apparent to those skilled in the art without departing from the scope and spirit of the present invention. The scope of the present invention, therefore, is to be determined solely by the following claims.

What is claimed is:

1. A display device comprising:
a display panel configured to display images;
a back member disposed on a back side of the display panel and including an opening;
a first mounting member provided on the back member;
a second mounting member provided on the back member and disposed on a side opposite from the opening, with the first mounting member being arranged between the opening and the second mounting member;
a speaker mounted on one of the first mounting member or the second mounting member and including a sound output unit configured to output sound; and
a first covering surface provided on the back member; wherein
if a size of the speaker is a first size, the speaker is mounted on the first mounting member such that the sound output unit is disposed at the opening; and
if the size of the speaker is a second size that is smaller than the first size, the speaker is mounted on the second mounting member such that the sound output unit faces toward the opening, and the first covering surface covers at least a portion of a first space between the opening and the sound output unit.

2. The display device according to claim 1, wherein
the first covering surface covers the entire circumference of the first space; and
a diameter of the first covering surface expands toward the opening from the sound output unit of the speaker that is mounted on the second mounting member.

3. The display device according to claim 1, wherein
the back member includes a back casing disposed on the back side of the display panel and a cover member that covers a portion of the back casing from outside; and
the speaker is sandwiched between the back casing and the cover member when mounted on either the first mounting member or the second mounting member.

4. The display device according to claim 3, further comprising a seal member interposed between the speaker and the back casing and the cover member.

5. The display device according to claim 1, wherein
the first mounting member and the second mounting member each include one of a protrusion and an indent;
the speaker includes the other of the protrusion and the indent, and
the speaker is mounted on one of the first mounting member and the second mounting member as a result of the protrusion being inserted into the indent.

6. The display device according to claim 1, further comprising:
a third mounting member provided on the back member and disposed on the side opposite from the opening, with the second mounting member being arranged between the opening and the third mounting member; and
a second covering surface provided on the back member and disposed on the side opposite from the opening, with the first covering surface being arranged between the opening and the second covering surface; and
if the size of the speaker is a third size that is smaller than the second size, then the speaker is mounted on the third mounting member such that the sound output unit faces toward the opening, and the first covering surface and the second covering surface cover at least a portion of a second space between the opening and the sound output unit.

7. The display device according to claim 6, wherein
the first covering surface and the second covering surface cover the entire circumference of the second space; and
a diameter of each of the first covering surface and the second covering surface expands toward the opening from the sound output unit of the speaker that is mounted on the third mounting member.

8. The display device according to claim 1, wherein the opening is provided at the lower end portion of the back member.

9. The display device according to claim 1, further comprising a pair of brackets on the speaker on the side opposite from the sound output unit.

10. The display device according to claim 9, wherein indents are provided in the pair of brackets.

11. The display device according to claim 10, wherein the indents are separated from each other by an interval.

12. The display device according to claim 9, wherein protrusions are provided in the pair of brackets.

13. The display device according to claim 12, wherein the protrusions are separated from each other by an interval.

14. The display device according to claim 1, further comprising cutouts in the back member.

15. The display device according to claim 1, further comprising protrusions in the back member.

16. The display device according to claim 1, wherein the first mounting member and the second mounting member each includes at least one of a protrusion and an indent.

17. The display device according to claim 6, wherein the third mounting member includes at least one of a protrusion and an indent.

18. The display device according to claim 1, wherein the back member includes a curved concave portion.

19. The display device according to claim 6, wherein each of the first covering surface and the second covering surface has one of a curved shape, a polyhedron shape, a trumpet shape, and a shape defined by circular or substantially circular cylinders with different diameters.

20. The display device according to claim 1, wherein the first mounting member and the second mounting member each includes a protrusion provided on a rear frame or a rear cover.
